(19) United States
(12) Patent Application Publication
(10) Pub. No.: US 2007/0283333 A1
(43) Pub. Date: Dec. 6, 2007

(54) Medium for recording compiler program, compile method, and information processing apparatus therewith

(76) Inventor: Ryuji Sakai, Hanno-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/806,371

(22) Filed: May 31, 2007

(30) Foreign Application Priority Data
May 31, 2006 (JP) 2006-152717

(51) Int. Cl. G06F 9/45

(52) U.S. Cl. 717/140

(57) ABSTRACT

According to one embodiment, a recording medium which records a compiler program which is loaded on a memory of a computer and executed to have the following functions analyzing a source program to detect a branched part in control of the program, and dividing the source program into divided programs which are program pieces executed without the branched part and parts executed while being branched.

### CROSS-REFERENCE TO RELATED APPLICATIONS

This application is based upon and claims the benefit of priority from Japanese Patent Application No. 2006-152717, filed May 31, 2006, the entire contents of which are incorporated herein by reference.

### BACKGROUND

1. Field

One embodiment of the present invention relates to a compile method for a computer program and, more particularly, to a medium for recording a compiler program that processes pieces which are obtained by dividing a program and which can be processed without branch, a compile method, and an information processing apparatus therewith.

2. Description of the Related Art

A compile process is performed in execution of a computer program. In relation to this, control flow analysis or the like is known.

Patent Document (Jpn. Pat. Appln. KOKAI Publication No. 2003-330741) discloses a technique for dividing a program in units of procedures, and unloading a less-frequently used module to improve efficiency in use.

The conventional technique in Patent Document 1 has the following program. A less-frequently used procedure module in the program is unloaded, and only an error process or the like which is not frequently used in one procedure cannot be excluded.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram for explaining an example of a compiler function according to an embodiment of the present invention;

FIG. 2 is a diagram for explaining an example of a function of an information processing system having the compiler function according to the embodiment of the present invention;

FIG. 3 is a flow chart for explaining an example of the compiler function according to the embodiment of the present invention;

FIG. 4 is a flow chart showing an example of a dividing program process according to the embodiment of the present invention;

FIG. 5 is a flow chart showing an example of a subroutine of the dividing program process according to the embodiment of the present invention;

FIG. 6 is a flow chart showing an example of an execution process of a VM code according to the embodiment of the present invention;

FIG. 7 is a diagram for explaining an example of an outline of a program dividing process by the compiler function according to the embodiment of the present invention; and

FIG. 8 is a diagram for explaining a concrete example of the program dividing process by the compiler function according to the embodiment of the present invention.

### DETAILED DESCRIPTION

Various embodiments according to the invention will be described hereinafter with reference to the accompanying drawings. In general, according to one embodiment of the invention, a recording medium which records the following program in a storage region, a compiler program which is loaded on a memory of a computer and executed to have the following functions: analyzing a source program to detect a branched part in control of the program; and dividing the source program into divided programs which are program pieces executed without the branched part and parts executed while being branched.

An embodiment of the present invention provides a compile method and an information processing apparatus which compile pieces which are obtained by dividing a program and can be processed without branch, load the pieces on a cache, and process the pieces to improve execution efficiency of the program.

One embodiment provides a recording medium which records a compiler program which is loaded on a memory of a computer and executed to have the following functions: analyzing a source program to detect a branched part in control of the program; and dividing the source program into divided programs P1 to P5 which are program pieces executed without the branched part and parts C1 to C5 executed while being branched.

There is further provided a compile method comprising: analyzing a source program to detect a branched part in control of the program; and dividing the source program into divided programs (P1 to P5) which are program pieces executed without the branched part and parts (C1 to C5) executed while being branched to compile the source program.

In this manner, an instruction code or the like of a program such as a less-frequently used error process is less frequently loaded on a cache memory or the like. For this reason, efficiency in execution of the program can be improved.

An embodiment of the present invention will be described below in detail with reference to the accompanying drawings.

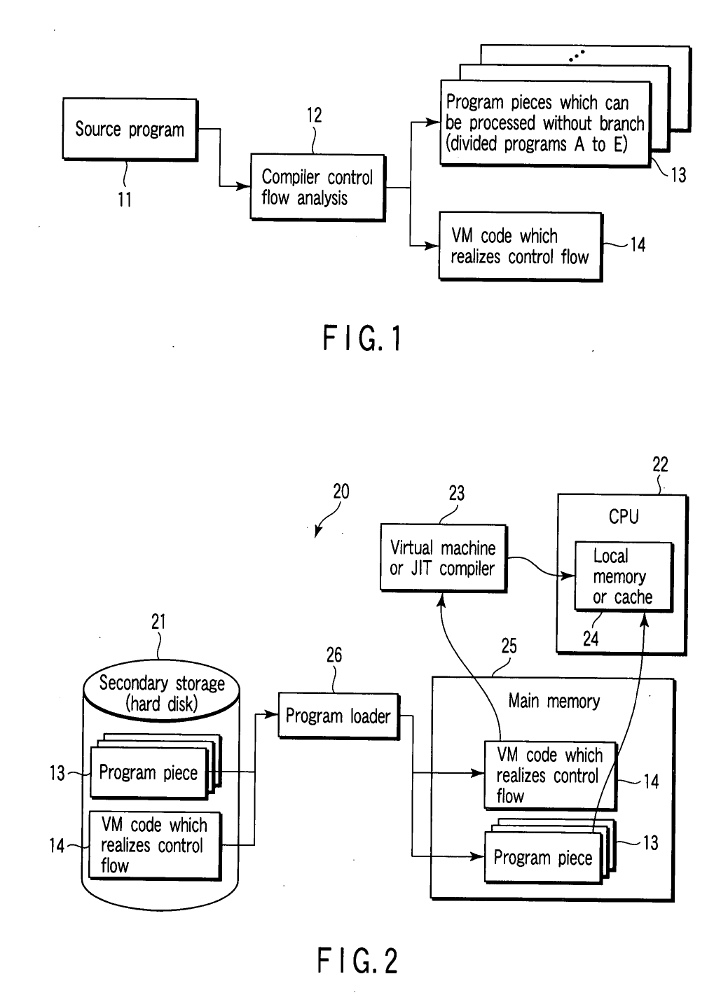

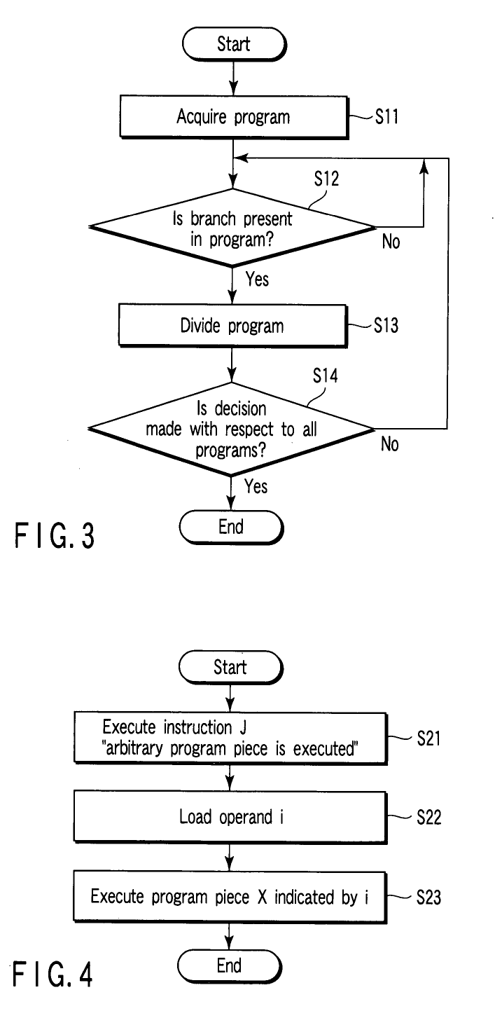

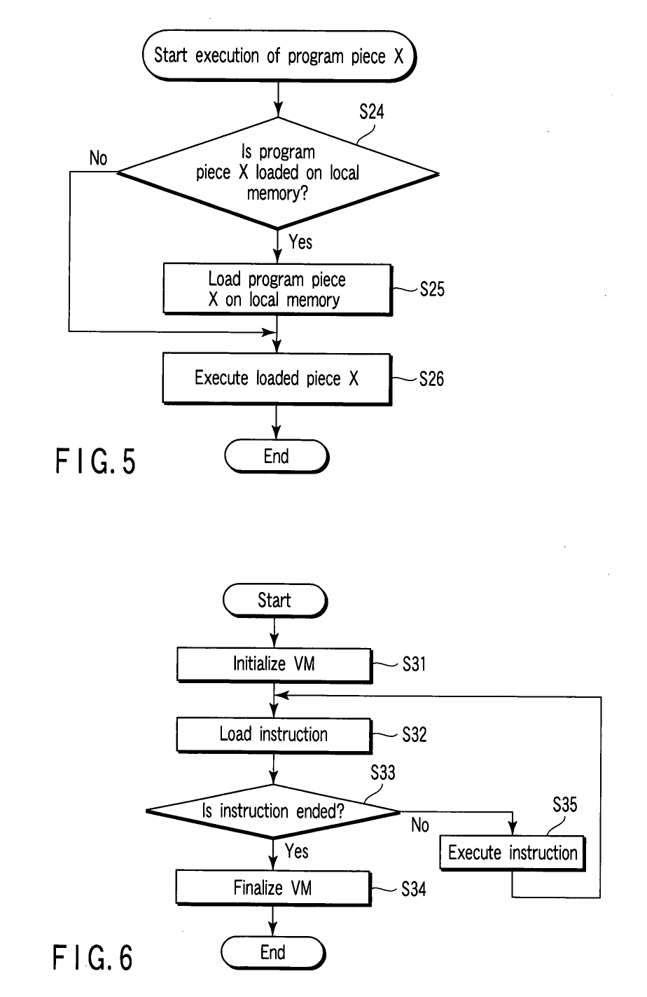

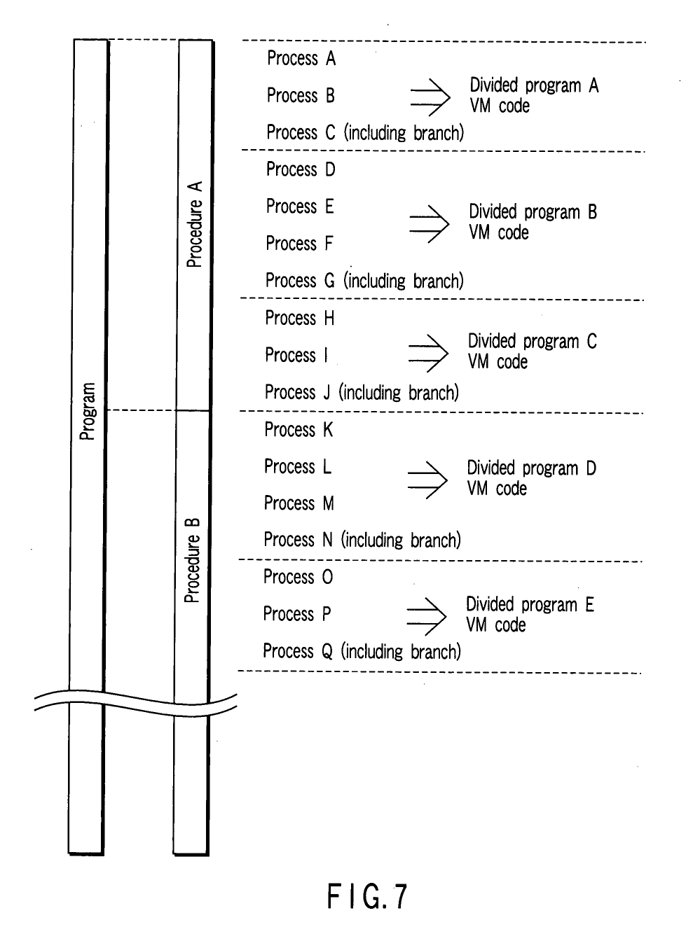

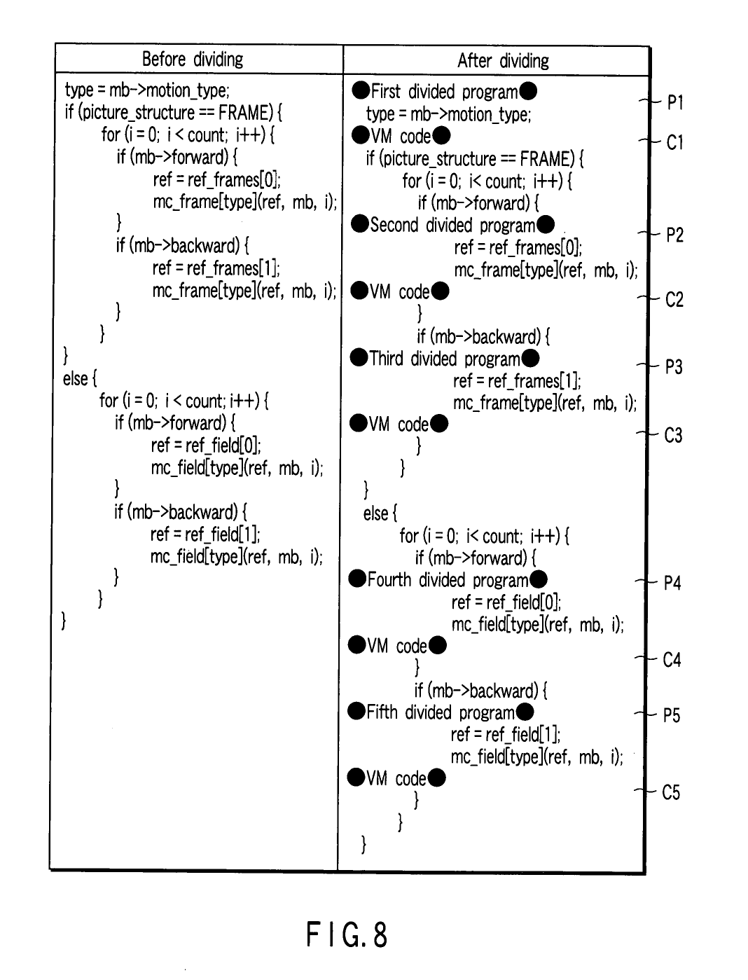

FIG. 1 is a diagram for explaining an example of a compiler function according to an embodiment of the present invention. FIG. 2 is a diagram for explaining an example of a function of an information processing system having the compiler function. FIG. 3 is a flow chart for explaining an example of the compiler function. FIG. 4 is a flow chart showing an example of a dividing program process. FIG. 5 is a flow chart showing an example of a subroutine of the dividing program process. FIG. 6 is a flow chart showing an example of an execution process of a VM code. FIG. 7 is a diagram for explaining an example of an outline of a program dividing process by the compiler function. FIG. 8 is a diagram for explaining a concrete example of the program dividing process by the compiler function.

### COMPILE METHOD ACCORDING TO ONE EMBODIMENT OF THE PRESENT INVENTION

### Outline of Compile Method

In general, a large part of execution time of a program is occupied by only a small part of the program, and this part is preferably executed at high speed. It is generally performed to set a frequently-executed instruction code in a high-speed cache memory to execute the instruction code. However, when a code size of a program increases, an instruction cache becomes short, and a cache miss frequently occurs to cause a decrease in execution efficiency. In particular, in an embedded device, since a cache memory which occupies a large area of an LSI cannot be easily increased in size, the cache memory must be efficiently used.

In consideration of the details of a large-scale program, a large part of a program code is occupied by error handling in many cases. These processes are not executed by a general normal path. For this reason, when a line size of the cache memory is sufficiently small, these program codes do not largely occupy the cache memory. However, with an increase in speed of a memory, a line size of a cache tends to increase. For this reason, some error handling may be loaded on the cache.

In a case in which a programmer purposely uses a local memory such as a scratch pad or a local storage, a code is generally DMA-transferred from a main memory onto the local memory in units of parts of a program to execute the program. In this case, when error handling is written by a syntax such as if-then-else, a program code is transferred to the local memory together with a program of a normal path to worsen use efficiency of the local memory.

In general, a configuration of a program can be classified into procedures A, B, . . . , as will be described in FIG. 7. Furthermore, the procedure can be classified into a process A, a process B, . . . , a process Q. In this case, in a general compile process, since the procedure A and the procedure B are loaded on a cache while keeping a memory arrangement in compiling, error handling is disadvantageously loaded on the cache simultaneously with processing of a normal path.

Therefore, in the compile method according to the embodiment of the present invention, as shown in FIG. 1, compiler/control flow analysis 12 is performed to a source program 1 to divide the source program 1 into program pieces 13 which can be serially executed without branch, and the program is held by a VM code which simultaneously realizes control flows and states of the plurality of divided programs. In an actual operation, execution address positions of necessary pieces are allocated to a cache or the like.

In this manner, error handling which cannot be executed in general is not loaded on a cache, and a program of a normal path can be arranged in continuous regions. For this reason, efficiency of execution of the program is improved. When program codes are executed while being output or input in a limited memory space such as a scratch pad or a local storage, the number of times of replacing programs can be reduced.

(Information Processing Apparatus to Realize Compile Method)

An example of an information processing apparatus 20 to realize a compile method according to the embodiment of the present invention will be described below with reference to FIG. 2. The information processing apparatus 20 to realize the compile method has a CPU 22 and a secondary storage (hard disk) 21 in which the program pieces 13 and a VM code 14 for realizing a control flow are stored, and has, as functional configurations, a program loader 26 and a virtual machine or a JIT compiler 23. Furthermore, the information processing apparatus 20 has a main memory 25 and a local memory or a cache 24. In the information processing apparatus, a compile process and a program process are performed as follows.

(Operation)

First, a compile process performed in the information processing apparatus 20 will be described in detail with reference to the flow chart in FIG. 3 and FIGS. 7 and 8. First, a source program is acquired by a JIT compiler such as Java™ realized by the information processing apparatus 20 and functioning on a virtual machine (step S11), and it is determined whether the program has a branch (step S12). In FIG. 7, it is detected that a process C, a process G, a process J, a process N, a process Q, and the like include branches.

On the basis of this, a program is divided into parts (to be referred to as basic blocks) which are serially executed by control of the program without branch (step S13). In FIG. 7, the program is divided into divided programs A, B, C, D, E, and the like to also generate VM codes. In FIG. 8, divided programs P1 to P5 and VM codes C1 to C5 are generated.

The divided pieces are encoded into objective codes as PIC codes. At the same time, a code is generated by using a control flow as a virtual instruction sequence of a virtual machine. The pieces 13 of the program codes and an instruction code 14 of the virtual machine constitute a program substance. In general, the pieces 13 and the instruction code 14 are stored in the secondary storage 21 such as a hard disk. These compile processes are performed to all the programs (step S14).

In execution of the program, as shown in the flow chart in FIG. 4, an instruction J “execute arbitrary program piece” is executed (step S21). More specifically, when an operand i is loaded (step S22), a program piece X represented by i is executed (step S23).

In execution of the program piece X by the instruction J, more specifically, as shown in the flow chart in FIG. 5, first, the substance of the hard disk is loaded on the main memory 25 under the control of the CPU 22, and processing is executed in accordance with execution of the virtual machine which executes a control structure. That is, at a timing of calling a program piece, i.e., a timing at which a virtual instruction is executed, the program piece is loaded from the main memory 25 onto the local memory 24. More specifically, it is determined whether the program piece X is loaded on the local memory 24 or the like (step S24). When the program piece X is not loaded, the program piece X is loaded on the local memory (step S25). This process is performed to an arbitrary program piece (step S26).

These processes are executed by processing a virtual code by a virtual machine such as Java™. More specifically, as shown in the flow chart in FIG. 6, after initialization of the VM code (step S31), the virtual code is loaded (step S32). When the instruction is not ended (step S33), the instruction of the virtual code is executed (step S35). In step S33, when the instruction is ended, thereafter, a finalizing process of the VM is performed (step S34).

In this case, the virtual code can also be executed by an interpreter of a virtual machine or can also be executed by being developed into native codes by a JIT compiler.

Furthermore, in the JIT compiling, according to a calling flow of a program piece, a code arrangement for a local memory can also be optimized.

### EXAMPLE OF CONCRETE COMPILE PROCESS

An example of a concrete compile process of a program will be described below with reference to FIG. 8.

FIG. 8 shows a part of a program of MC (Motion Compensation) of an MPEG2 decoder. In this case, a picture structure is fixed to each stream in many cases. The decoder implements a program to make it possible to decode all streams conforming to the standard. For example, in a frame structure, the contents of the first “if” are executed. On the other hand, in the field structure, a part of “else” in the second half is executed.

When codes are transferred to a high-speed memory in units of modules, both the codes are loaded on the memory. In the embodiment of the present invention, only one of the codes is loaded on the high-speed memory.

An example obtained after the program is divided is shown in the right part in FIG. 8. More specifically, an if statement and a for statement are to be divided. Since the sentences are control parts, the statements are generated as an output from the compiler and a code on the VM side. In FIG. 8, the program is divided into a first divided program P1 to a fifth divided program P5 and five VM codes C1 to C5.

Since an execution code on the VM side can be executed at a high speed by being Just-In-Time-compiled, the VM code is not necessarily used.

In the above embodiment, although a program is divided into pieces by a compiler, in a description stage of the program, it is preferable that a control structure and a program sequence be divisionally described. Furthermore, in this case, by using a language which describes parts that can be executed in parallel to each other, a VM which executes a control flow can effectively assign the parts which can be parallel executed to sleds, respectively.

As described above, by a compile process and an execution process of a program according to the embodiment of the present invention, cache miss of instruction codes of a large-scale program can be reduced. In an environment in which a program is loaded and unloaded on a high-speed memory such as a scratch pad or a local storage and executed, the number of times of loading/unloading a program can be reduced.

According to various embodiments described above, a person skilled in the art can realize the present invention. Furthermore, various modifications of these embodiments can be easily conceived by the person skilled in the art. The present invention can be applied to various embodiments without inventive ability. Therefore, the present invention ranges in scope without departing from the disclosed principles and novel characteristics, and the present invention is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording medium which records the following program in a storage region,
a compiler program which is loaded on a memory of a computer and executed to have the following functions:
analyzing a source program to detect a branched part in control of the program; and
dividing the source program into divided programs which are program pieces executed without the branched part and parts executed while being branched.

2. The recording medium according to claim 1, wherein the compiler program further encodes the divided programs into objective codes as PIC codes.

3. A compile method comprising:
analyzing a source program to detect a branched part in control of the program; and
dividing the source program into divided programs which are program pieces executed without the branched part and parts executed while being branched to compile the source program.

4. The compile method according to claim 3, wherein the divided programs are encoded into objective codes as PIC codes.

5. An information processing apparatus having a first storage region, a second storage region having a read speed higher than that of the first storage region, and a processing unit, wherein
a source program is analyzed as an operation of the processing unit to detect a branched part in control of the program; and
the source program is divided into divided programs which are program pieces executed without the branched part and parts executed while being branched to store the divided programs and the parts in the first storage region; and
the compiled divided programs are loaded on the second storage region and executed.

6. The information processing apparatus according to claim 5, wherein virtual codes which are the parts executed while being branched are executed by an interpreter of a virtual machine.

7. The information processing apparatus according to claim 5, wherein virtual codes which are the parts executed while being branched are developed into native codes and executed by a JIT compiler.
